(19) United States
(12) Patent Application Publication
(10) Pub. No.: US 2010/0235597 A1
(43) Pub. Date: Sep. 16, 2010

(54) METHOD AND APPARATUS FOR CONVERSION BETWEEN CONVENTIONAL VOLUMES AND THIN PROVISIONING WITH AUTOMATED TIER MANAGEMENT

(76) Inventor: Hiroshi Arakawa, Sunnyvale, CA (US)

Correspondence Address: MATTINGLY & MALUR, P.C., 1800 DIAGONAL ROAD, SUITE 370, ALEXANDRIA, VA, 22314, US

(21) Appl. No.: 12/400,976

(22) Filed: Mar. 10, 2009

(51) Int. Cl. G06F 12/00; G06F 12/02

(52) U.S. Cl. 711/163; 711/170; 711/E12.001; 711/E12.002

(57) ABSTRACT

A method for providing storage volumes, which are to be converted to thin provisioned volumes, comprises receiving from a host computer a read/write request identifying a target storage volume among the storage volumes and a target area of access; processing the read/write request and updating an access information of the target storage volume; if the target storage volume does not have access information, generating access information for the converted thin provisioned volume from initial values; and if the target storage volume has access information, generating access information for the converted thin provisioned volume based on the access information of the target storage volume.

### BACKGROUND OF THE INVENTION

The present invention relates generally to storage systems and, more particularly, to a method and an apparatus to record and utilize access information in a conversion process between conventional volumes and thin provisioned volumes.

Hierarchical storage management also called tier management is a storage management method designed for improving utilization of storage resources in computer systems. Specifically, the utilization of resources is optimized by changing the location of data in a computer system based on the worth and usage of the data in the enterprise. On the other hand, the analysis and classification of the aforesaid worth and the usage are generally difficult tasks. Therefore, recently some storage system vendors proposed automated page-based hierarchical storage management performed by the storage system itself. With this function, the storage system itself monitors access characteristics of each small data storage area, such as a page, in a data storage volume or a file system region, and automatically relocates the data in the page based on the detected access characteristics. The data relocation is performed regardless of the usage of the data in the host or application side. For example, Compellent provides storage system products having automated page-based management or automated tire management capability. See http://www.compellent.com/Products/Software/Automated-Tiered-Storage.aspx.

Using pages mentioned above for providing data storage volumes can achieve reduction of storage cost, management cost, and power consumption. This approach is called thin provisioning for storage. With thin provisioning, a storage system provides virtual volumes as the storage area to store data for computers. For the virtual volumes, the storage system allocates and assigns a physical area to only a location having write access of the computers. The total amount of used physical area in a pool can be smaller than the total amount of virtual area shown to the computers. To realize this capability, the storage system divides the storage area (e.g., storage area in HDD or flash memory) into a plurality of fixed-length areas called chunks or pages, and manages mapping between chunks and logical segments in the virtual volumes.

Because an old and conventional method to provide data storage volumes is to assign the storage area to the whole area of the volumes at the creation of the volumes, a conversion process from conventional volumes to thin provisioned volumes (TPV) is required to achieve the above advantages such as the reduction of storage cost. For example, U.S. Pat. No. 7,162,600 to Kano discloses methods for migration between normal (not thin provisioning) volumes and thin provisioned volumes. In addition, conversion from TPVs to conventional volumes is also needed because the conventional method has an advantage from the performance perspective, since it does not involve a process to obtain an actual page having designated data from mapping relation between the area of virtual volume and pages.

With regard to the automated page-based hierarchical storage management, however, the management such as proper relocation does not work immediately after the conversion because the monitoring of access characteristics is started after the conversion even if the conversion is performed in order to achieve superior utilization of storage resources. In other words, it requires considerable time to realize an effect of the automated page-based hierarchical storage management after the conversion of volumes.

### BRIEF SUMMARY OF THE INVENTION

Exemplary embodiments of the invention provide a method and an apparatus to accomplish prompt improvement of utilization of storage resources with thin provisioning and automated page-based hierarchical storage management even with having conversion of volumes between conventional volume and TPV. With the presented invention, a storage system that provides conventional volumes and TPVs to host computers has a capability to monitor access characteristics of conventional volumes and a capability to continuously use the access characteristic information of a conventional volume as access characteristic information of a TPV in conversion from the conventional volume to the TPV. Efficient use and assignation of storage resources based on past access characteristics are performed immediately. In addition, the storage system maintains the historical access characteristics information with multiple bidirectional conversions between conventional volume and TPV. As another embodiment, plural storage systems exchange access characteristics information to maintain history of access characteristic with conversion of volumes between the storage systems.

An aspect of the present invention is directed to a method for providing storage volumes which are to be converted to thin provisioned volumes. The method comprises receiving from a host computer a read/write request identifying a target storage volume among the storage volumes and a target area of access; if the read/write request is a read request, transferring data stored in the target area of access of the target storage volume to the host computer, and updating an access information of the target storage volume; if the read/write request is a write request containing write data, storing the write data in the target area of access of the target storage volume, and updating an access information of the target storage volume; if the target storage volume does not have access information, generating access information for the converted thin provisioned volume from initial values; and if the target storage volume has access information, generating access information for the converted thin provisioned volume based on the access information of the target storage volume.

In some embodiments, the method further comprises determining whether there is a need to relocate data in the converted thin provisioned volume by referring to the generated access information. In specific embodiments, the method further comprises prior to updating the access information of the target storage volume, determining whether to update the access information by checking a “record access information” flag in a volume information regarding the target storage volume. The size of segments of the target storage volume is equal to an integral multiple of the segment size of the thin provisioned volume.

In some embodiments, during a relocation process of the converted thin provisioned volume, the method further comprises determining a location that stores data in the converted thin provisioned volume by using the generated access information. The access information for the thin provisioned volume is generated based on the access information of the storage volume, and the method further comprises, for each segment of a plurality of segments of the thin provisioned volume, determining whether there is a need to assign a chunk for said each segment; and if there is a need to assign a chunk for said each segment, determining a chunk to be assigned for said each segment according to the access information of the thin provisioned volume, assigning the chunk for said each segment, and copying data from the storage volume to the assigned chunk. The storage volumes may be disposed in a first storage system, and are to be converted to the thin provisioned volumes disposed in a second storage system.

Another aspect of the invention is directed to a system for providing storage volumes which are to be converted to thin provisioned volumes. The system comprises a host computer; and a first storage system connected with the host computer via a network, wherein the first storage system includes a first storage area and a storage controller which has a processor. The storage controller is configured to receive from a host computer a read/write request identifying a target storage volume among the storage volumes in the first storage area of the first storage system, and a target area of access. If the read/write request is a read request, the storage controller transfers data stored in the target area of access of the target storage volume to the host computer, and updates an access information of the target storage volume. If the read/write request is a write request containing write data, the storage controller stores the write data in the target area of access of the target storage volume, and updates an access information of the target storage volume. If the target storage volume does not have access information, the storage controller generates access information for the converted thin provisioned volume from initial values. If the target storage volume has access information, the storage controller generates access information for the converted thin provisioned volume based on the access information of the target storage volume.

In some embodiments, a second storage system is connected with the first storage system. The second storage system includes a second storage area. The storage volumes are disposed in the first storage area of the first storage system and are to be converted to the thin provisioned volumes disposed in the second storage area of the second storage system.

Another aspect of the invention is directed to a computer-readable storage medium storing a plurality of instructions for controlling a data processor to provide storage volumes which are to be converted to thin provisioned volumes. The plurality of instructions comprise instructions that cause the data processor to receive from a host computer a read/write request identifying a target storage volume among the storage volumes and a target area of access; if the read/write request is a read request, instructions that cause the data processor to transfer data stored in the target area of access of the target storage volume to the host computer, and update an access information of the target storage volume; if the read/write request is a write request containing write data, instructions that cause the data processor to store the write data in the target area of access of the target storage volume, and update an access information of the target storage volume; if the target storage volume does not have access information, instructions that cause the data processor to generate access information for the converted thin provisioned volume from initial values; and if the target storage volume has access information, instructions that cause the data processor to generate access information for the converted thin provisioned volume based on the access information of the target storage volume.

These and other features and advantages of the present invention will become apparent to those of ordinary skill in the art in view of the following detailed description of the specific embodiments.

### BRIEF DESCRIPTION OF THE DRAWINGS

FIG. 1 illustrates an overview of conversion from conventional volumes to thin provisioned volumes (TPVs) as one example of conversion between conventional volumes and TPVs according to an embodiment of the invention.

FIG. 2 illustrates an example of a hardware configuration in which the method and apparatus of the invention may be applied.

FIG. 3 illustrates a structure and a method to provide TPVs by assigning chunks of pool volumes to segments of the TPVs.

FIG. 4 illustrates an example of mapping information between chunks and segments of each volume.

FIG. 5 shows an example of pool information used for managing whether a chunk is used or not.

FIG. 6 shows an example of volume information of the volumes.

FIG. 7 is a flow diagram illustrating an overview of a process for a write request from the host computer.

FIG. 8 is a flow diagram illustrating an overview of a process for a read request from the host computer.

FIG. 9 is a flow diagram illustrating a write process for the TPV.

FIG. 10 illustrates an example of access information regarding access for the segments.

FIG. 11 is a flow diagram illustrating a read process for the TPV.

FIG. 12 is a flow diagram illustrating a relocation decision process for the relocation of data in a segment.

FIG. 13 shows an example of relocation condition used to determine whether relocation of data in the segment should be performed in FIG. 12.

FIG. 14 is a flow diagram illustrating the relocation process in FIG. 12.

FIG. 15 shows an example of the relocation information for the segments in the relocation process of FIG. 12.

FIG. 16 is a flow diagram illustrating a write process for the conventional volume.

FIG. 17 shows an example of access information for the conventional volume.

FIG. 18 is a flow diagram illustrating a read process for the conventional volume.

FIG. 19 is a flow diagram illustrating an example of the general conversion process.

FIG. 20 is a flow diagram illustrating another example of the general conversion process.

FIG. 21 shows an example of segment relation between a volume to be converted and a converted volume, i.e., between the source and destination of conversion.

FIG. 22 shows another example of segment relation between a volume to be converted and a converted volume.

FIG. 23 shows another example of segment relation between a volume to be converted and a converted volume.

FIG. 24 illustrates an overview of conversion from conventional volumes to thin provisioned volumes (TPVs) according to another embodiment of the invention.

### DETAILED DESCRIPTION OF THE INVENTION

In the following detailed description of the invention, reference is made to the accompanying drawings which form a part of the disclosure, and in which are shown by way of illustration, and not of limitation, exemplary embodiments by which the invention may be practiced. In the drawings, like numerals describe substantially similar components throughout the several views. Further, it should be noted that while the detailed description provides various exemplary embodiments, as described below and as illustrated in the drawings, the present invention is not limited to the embodiments described and illustrated herein, but can extend to other embodiments, as would be known or as would become known to those skilled in the art. Reference in the specification to “one embodiment”, “this embodiment”, or “these embodiments” means that a particular feature, structure, or characteristic described in connection with the embodiment is included in at least one embodiment of the invention, and the appearances of these phrases in various places in the specification are not necessarily all referring to the same embodiment. Additionally, in the following detailed description, numerous specific details are set forth in order to provide a thorough understanding of the present invention. However, it will be apparent to one of ordinary skill in the art that these specific details may not all be needed to practice the present invention. In other circumstances, well-known structures, materials, circuits, processes and interfaces have not been described in detail, and/or may be illustrated in block diagram form, so as to not unnecessarily obscure the present invention.

Furthermore, some portions of the detailed description that follow are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the present invention, the steps carried out require physical manipulations of tangible quantities for achieving a tangible result. Usually, though not necessarily, these quantities take the form of electrical or magnetic signals or instructions capable of being stored, transferred, combined, compared, and otherwise manipulated. It has proven convenient at times, principally for reasons of common usage, to refer to these signals as bits, values, elements, symbols, characters, terms, numbers, instructions, or the like. It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “processing”, “computing”, “calculating”, “determining”, “displaying”, or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

The present invention also relates to an apparatus for performing the operations herein. This apparatus may be specially constructed for the required purposes, or it may include one or more general-purpose computers selectively activated or reconfigured by one or more computer programs. Such computer programs may be stored in a computer-readable storage medium, such as, but not limited to optical disks, magnetic disks, read-only memories, random access memories, solid state devices and drives, or any other types of media suitable for storing electronic information. The algorithms and displays presented herein are not inherently related to any particular computer or other apparatus. Various general-purpose systems may be used with programs and modules in accordance with the teachings herein, or it may prove convenient to construct a more specialized apparatus to perform desired method steps. In addition, the present invention is not described with reference to any particular programming language. It will be appreciated that a variety of programming languages may be used to implement the teachings of the invention as described herein. The instructions of the programming language(s) may be executed by one or more processing devices, e.g., central processing units (CPUs), processors, or controllers.

Exemplary embodiments of the invention, as will be described in greater detail below, provide apparatuses, methods and computer programs for recording and utilizing access information in a conversion process between conventional volumes and thin provisioned volumes.

### A. First Embodiment

A.1. System Configuration

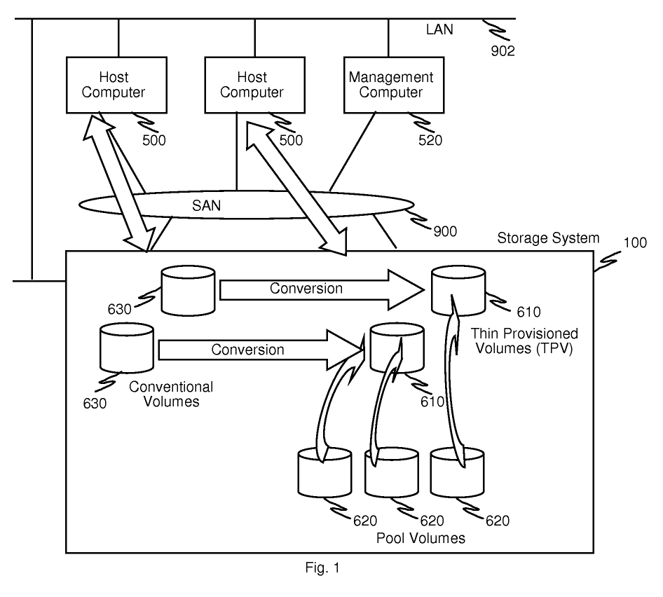

FIG. 1 illustrates an overview of conversion from conventional volumes 630 to thin provisioned volumes (TPVs) 610 as one example of conversion between conventional volumes and TPVs according to an embodiment of the invention. That is, the conventional volumes 630 are “volumes to be converted” and the TPVs 610 are “converted volumes” in this figure. Host computers 500 and management computer 520 are connected to one or more storage systems 100 by SAN 900 and LAN 902. The storage system 100 provides two types of data storage volumes to these computers: conventional volumes 630 and TPVs 610. As described below, the TPVs 610 reduce actual use of storage area thanks to on-demand assignation of the area while the whole area of volume is assigned to the conventional volume 630 at the creation of the conventional volumes 630. Moreover, automated page-based hierarchical storage management described below achieves efficient use of storage resources with the TPVs 610.

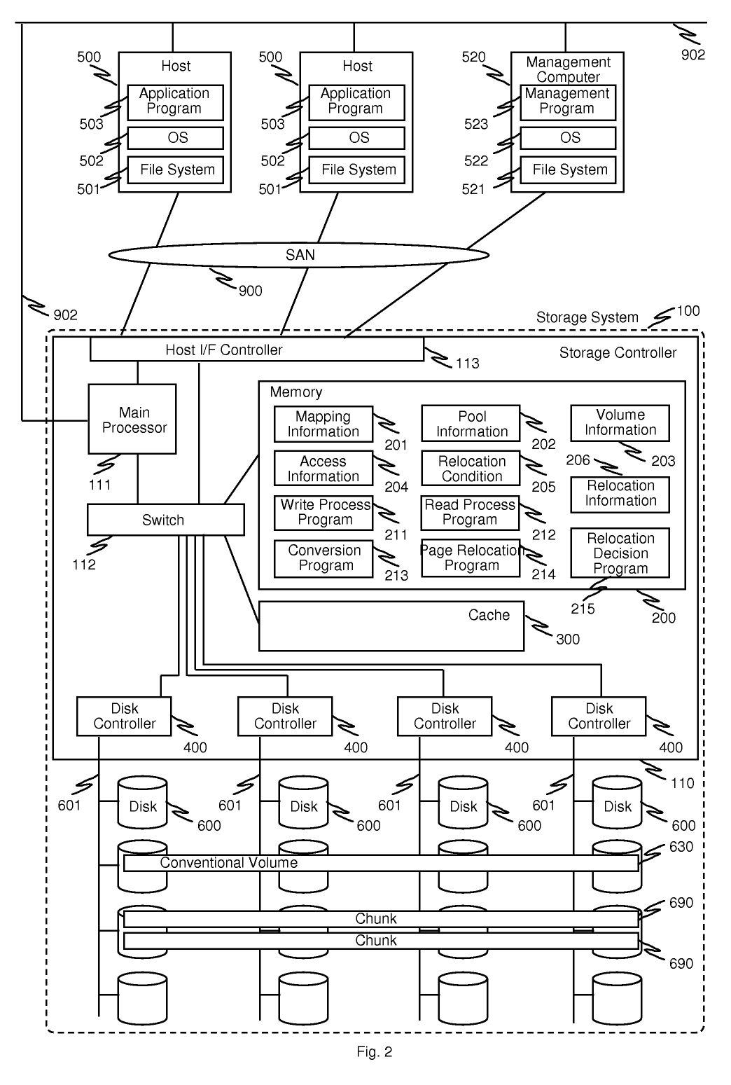

FIG. 2 shows the system configuration. A storage system 100 includes a storage controller 110 (having a main processor 111, a switch 112, a host interface 113, a memory 200, a cache 300, and at least one disk controller 400), at least one disk (e.g., HDD) 400, and at least one backend path 601 (e.g., Fibre Channel, SATA, SAS, or iSCSI(IP)). The main processor 111 performs various processes for the storage controller 100. The main processor 111 and other components use various information stored in the memory 200, including mapping information 201, pool information 202, volume information 203, access information 204, relocation condition 205, and relocation information 206. The main processor 111 performs the processes by executing various programs stored in the memory 200, including a write process program 211, a read process program 212, a conversion program 213, a page relocation program 214, and a relocation decision program 215.

The host 500 and management computer 520 are connected to the host interface 113 via the SAN 900 (e.g., Fibre Channel, Fibre Channel over Ethernet, or iSCSI(IP)). The host 500, management computer 520, and storage controller 110 are connected to each other via the LAN 902 (e.g., IP network). The host 500 has a file system 501, an operating system 502, and an application program 503. To execute these programs, the host 500 also has resources such as processor, memory, and storage devices not shown in FIG. 2 but known in the art. The management computer 520 has a file system 521, an operating system 522, and a management program 523. To execute these programs, the management computer 520 also has resources such as processor, memory, and storage devices not shown in FIG. 2 but known in the art.

Volumes (Logical Units or LUs) provided by the storage system 100 are produced from collection of areas in HDDs. They may be protected by storing parity code (i.e., by RAID configuration) or mirroring.

A.2. Overview of Method for Providing Volumes

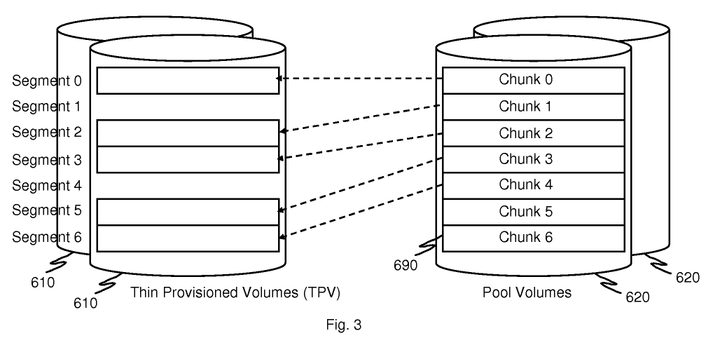

As mentioned above, the storage system 100 provides TPVs and conventional volumes. FIG. 3 illustrates a structure and a method to provide TPVs. The storage system 100 has pool volumes 620 and divides the pool volumes 620 into a number of fixed-length areas called chunk 690. The storage system 100 assigns a chunk 690 to a segment of a virtual volume (TPV) on write access. In other words, the physical storage area is assigned on demand. In FIG. 3, a TPV is constituted by multiple segments virtually, and a chunk 690 is allocated from the pool volumes 620 and assigned to a segment (i.e., a fixed length area (page) of the TPV). For example, chunk 4 is assigned to segment 6 in this figure. That is, a TPV is a page-based volume. To achieve this, the storage controller 110 uses mapping information 201 and pool information 202.

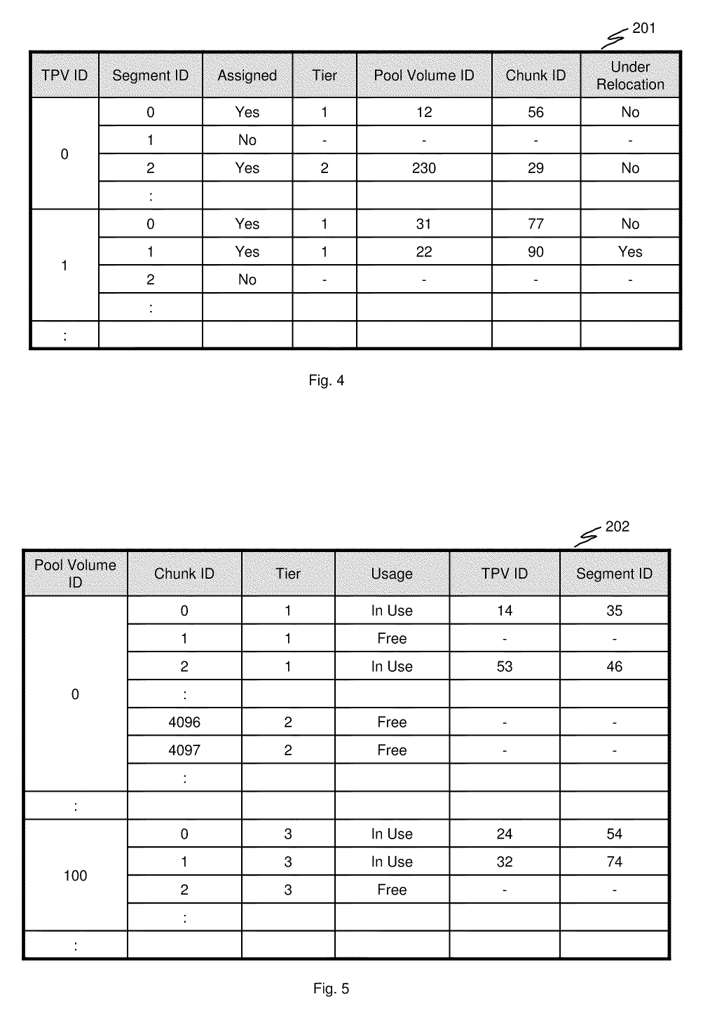

FIG. 4 shows an example of the mapping information 201. This information maintains mapping between chunks and segments of each volume. The status of assignation is “No” if no chunk is assigned to the segment. The tier to which the segment belongs at that time is indicated in the “Tier” section. A usage of flag of “Under Relocation” is described below. This information can be constructed as a list or a directory of each element for faster search.

FIG. 5 shows an example of the pool information 202. This information manages whether a chunk is used or not. By using this information, the storage controller 110 is able to find free (unused) chunks in the write process described below. The tier to which the chunk belongs at that time is indicated in the “Tier” section. This information also can be constructed as a list or a directory of each element to search a free chunk quickly.

As shown in U.S. Pat. No. 7,441,096, the storage system 100 can realize page-based transparent data relocation between chunks by copying data and changing mapping information 201.

The storage system 100 also provides conventional volumes. The storage controller 110 allocates storage areas to the whole area of the conventional volume 630 at creation of the volume as shown in FIG. 1. In order to manage the storage area for conventional volumes 630, the storage controller 110 uses volume information 203.

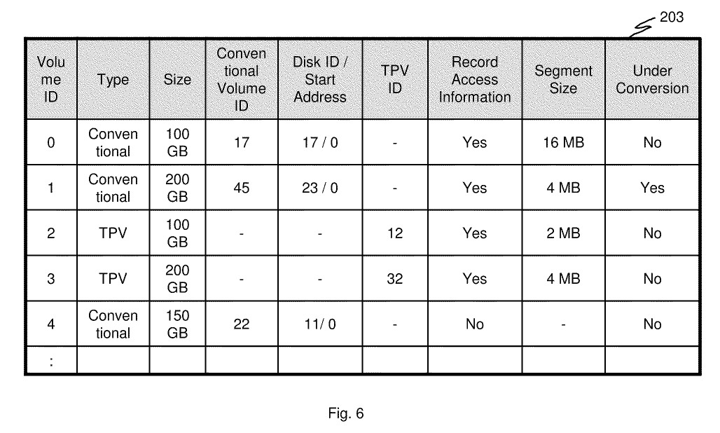

FIG. 6 shows an example of the volume information 203. This information includes the type (i.e., conventional or TPV), size, and public volume ID for each volume. This volume ID is used to recognize the volume by other computers including the host computers 500 while conventional volume ID and TPV ID are internal IDs basically. Because the volume information 203 has the volume size (area size) and location of area in the HDD 600 (disk ID and start address of the area in the disk) for conventional volumes, the storage controller 110 can manage and provide conventional volumes by using this information. The volume information 203 also maintains the relation (mapping) between the public volume ID and the conventional volume ID.

The volume information 203 is also used to supply TPVs as data storage volumes provided by the storage system 100 to the host 500, by referring to the TPV ID. In other words, the volume information 203 maintains the relation (mapping) between the public volume ID and the TPV ID. The volume information 203 also includes information regarding segment size of each volume of not only the TPV but the conventional volume. That is, both the TPV and conventional volume have a fixed-length segment. The segment size may be selectable and registered by the user via the host 500, the management computer 520, and/or the management terminal of the storage system 100. In addition, the volume information 203 has a “Record Access Information” flag and an “Under Conversion” flag as described below. The initial value of the “Record Access Information” flag is “Yes” and the initial value of the “Under Conversion” is “No.”

A.3. Overview of Write Process

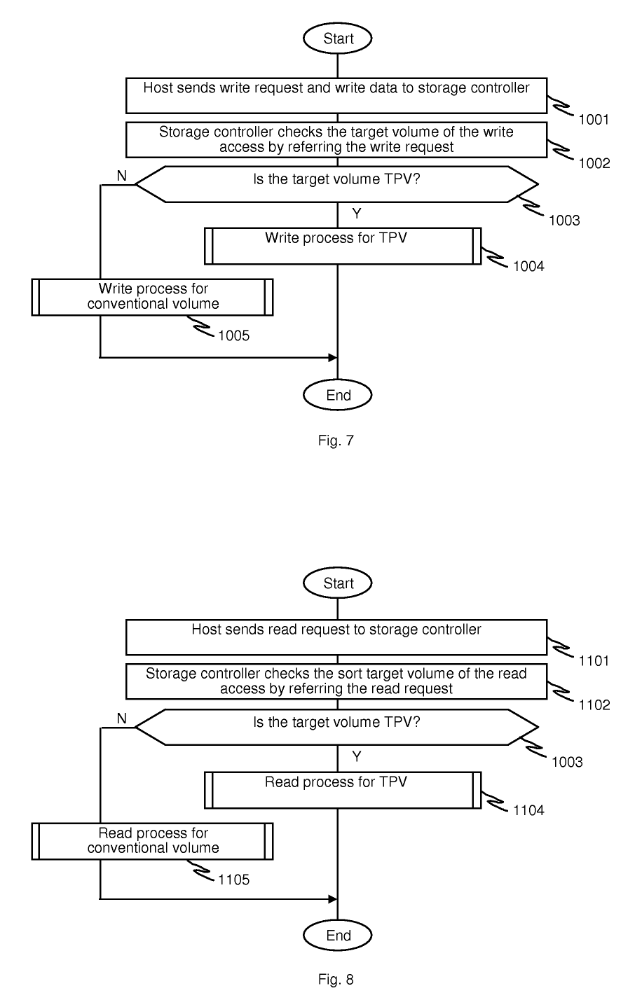

FIG. 7 is a flow diagram illustrating an overview of a process for a write request from the host computer 500. At step 1001, the host 500 issues a write request and transfers write data to the storage controller 110. At step 1002, the storage controller 110 checks the target volume of the write access by referring to the write request. At step 1003, if the type of the target volume is TPV, the storage controller 110 performs a write process for TPV (step 1004). Otherwise, the storage controller 110 performs a write process for conventional volume (step 1005). Each of the detailed write processes is described below.

A.4. Overview of Read Process

FIG. 8 a flow diagram illustrating an overview of a process for a read request from the host computer 500. At step 1101, the host 500 issues a read request to the storage controller 110. At step 1102, the storage controller 110 checks the target volume of the read access by referring to the read request. At step 1103, if the type of the target volume is TPV, the storage controller 110 performs a read process for TPV (step 1104). Otherwise, the storage controller 110 performs a read process for conventional volume (step 1105). Each of the detailed read processes is described below.

A.5. Write Process for TPV

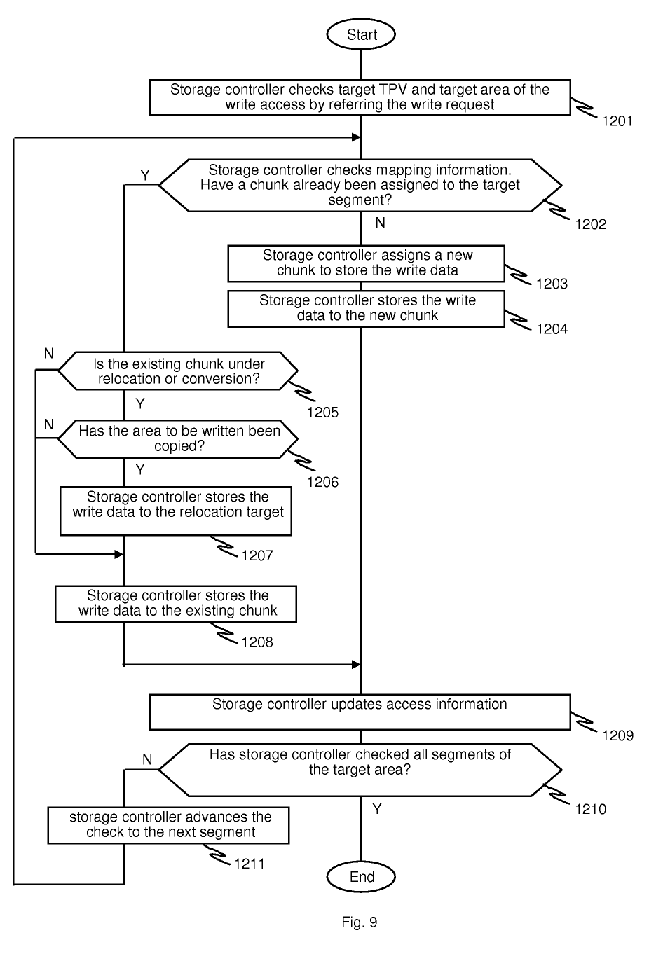

FIG. 9 is a flow diagram illustrating a write process for the TPV 610. At step 1201, the storage controller 110 checks the target TPV 610 and the target area of the write access by referring to the write request. At step 1202, the storage controller 110 checks the mapping information 201 for a segment in the target area. If a chunk has already been assigned to the segment, the process proceeds to step 1205. If not, the process proceeds to step 1203.

At step 1203 (a chunk has not been assigned), the storage controller 110 assigns a new chunk to store the write data. To do this, the storage controller 110 updates the mapping information 201 and pool information 202. By using the pool information 202, the storage controller 110 finds the new chunk from internal storage. At step 1204, the storage controller 110 stores the write data to the new chunk, and then the process proceeds to step 1209.

At step 1205 (a chunk has been assigned), the storage controller 110 checks the “Under Relocation” flag in the mapping information 201 and “Under Conversion” flag in the volume information 203. The “Under Relocation” flag is set in the relocation process described below and shows whether the chunk is under relocation or not. The “Under Conversion” flag is set in the conversion process described below and shows whether the chunk is under conversion as source of conversion or not. If the status is under relocation or under conversion, the process proceeds to step 1206. If not, the process proceeds to step 1208.

At step 1206 (under relocation or under conversion), by referring to the relocation information 206 described below, the storage controller 110 checks whether the area regarding write in the chunk has been copied in the relocation process. The storage controller 110 may also check the copy progress information for conversion process described below. If yes, the process proceeds to step 1207. If not, the process proceeds to step 1208. At step 1207, the storage controller 110 stores the write data to the relocation target or the converted volume, and then the process proceeds to step 1208. At step 1208, the storage controller 110 stores the write data to the existing chunk.

At step 1209, the storage controller 110 updates the access information 204. This information records access characteristics regarding the segment (i.e., page) and used for determination of relocation described below. At step 1210, if the storage controller 110 has checked all segments of the target area, the process ends. If not, the storage controller 110 advances the check to the next segment (step 1211).

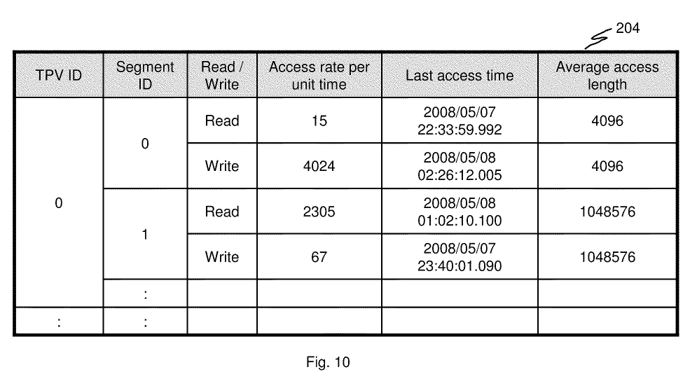

FIG. 10 illustrates an example of the access information 204 regarding access for the segments. This maintains information regarding access to each segment such as the access rate per unit time, last access time, and average access length, for each of read and write. The information regarding the average access length may be initialized at a certain interval.

A.6. Read Process for TPV

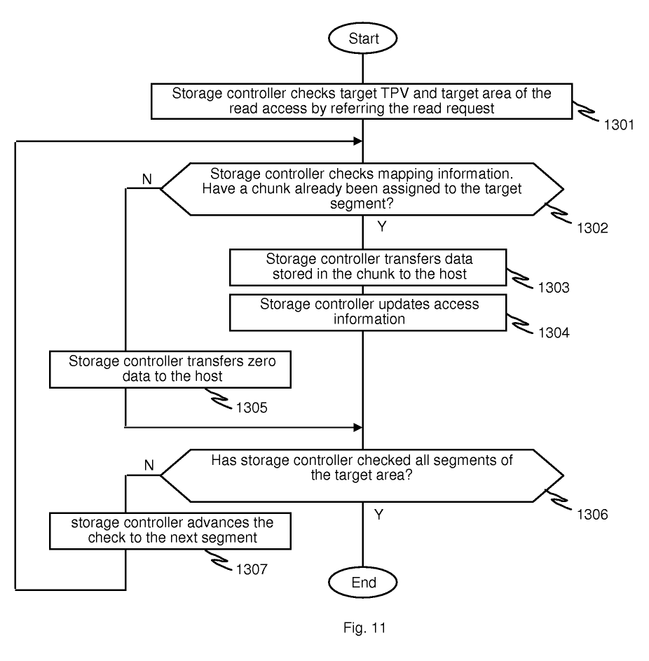

FIG. 11 is a flow diagram illustrating a read process for TPV 610. At step 1301, the storage controller 110 checks the target TPV 610 and target area of the read access by referring to the read request. At step 1302, the storage controller 110 checks the mapping information 201 for a segment in the target area. If a chunk has already been assigned to the segment, the process proceeds to step 1303. If not, the process proceeds to step 1305.

At step 1303 (a chunk has been assigned), the storage controller 110 transfers data stored in the chunk to the host 500. At step 1304, the storage controller 110 updates the access information 204. At step 1305 (a chunk has not been assigned), the storage controller 110 sends data of zero (0) to the host 500. Finally, at step 1306, if the storage controller 110 has checked all segments of the target area, the process ends. If not, the storage controller 110 advances the check to the next segment (step 1307).

A.7. Relocation Decision Process

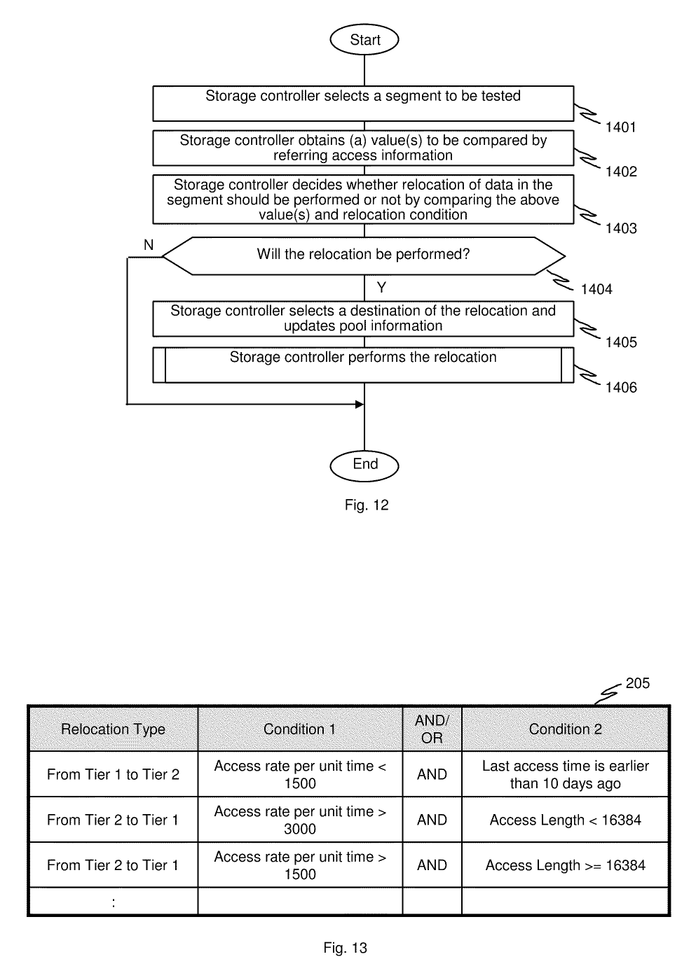

As mentioned above, the relocation of data can be performed for the TPV to achieve efficient use of storage resources. FIG. 12 is a flow diagram illustrating a relocation decision process for the relocation of data in a segment. It includes a process to determine whether the relocation will be performed or not, as well as the relocation.

At step 1401, storage controller 110 chooses a segment (i.e., page) to be examined. At step 1402, by referring to the access information 204, the storage controller 110 obtains one or more values to be compared with the relocation condition 205. At step 1403, the storage controller 110 decides whether the relocation of data in the segment should be performed according to the relocation condition 205. FIG. 13 shows an example of relocation condition 205. This information maintains the conditions to determine the occurrence of relocation for each movement between tiers. The condition may be registered by the user via the host 500, management computer 520, and/or management terminal of the storage system 100. The storage controller 110 can determine the occurrence by referring to (comparing) the above value(s) and the conditions.

At step 1404, if the relocation will be performed as a result of the decision, the process proceeds to step 1405. If not, the process ends. At step 1405, the storage controller 110 finds a destination of the relocation in a suitable tier determined from the condition and updates the pool information 202. At step 1406, the storage controller 110 performs the relocation. The detailed process is described below.

In order to adjust the actual location of data in the TPV 610 according to usage of data, the above relocation decision process is repeated at a predetermined interval or performed when the load of the storage system 110 is low. This process is performed for segments that have stored data.

A.8. Relocation Process

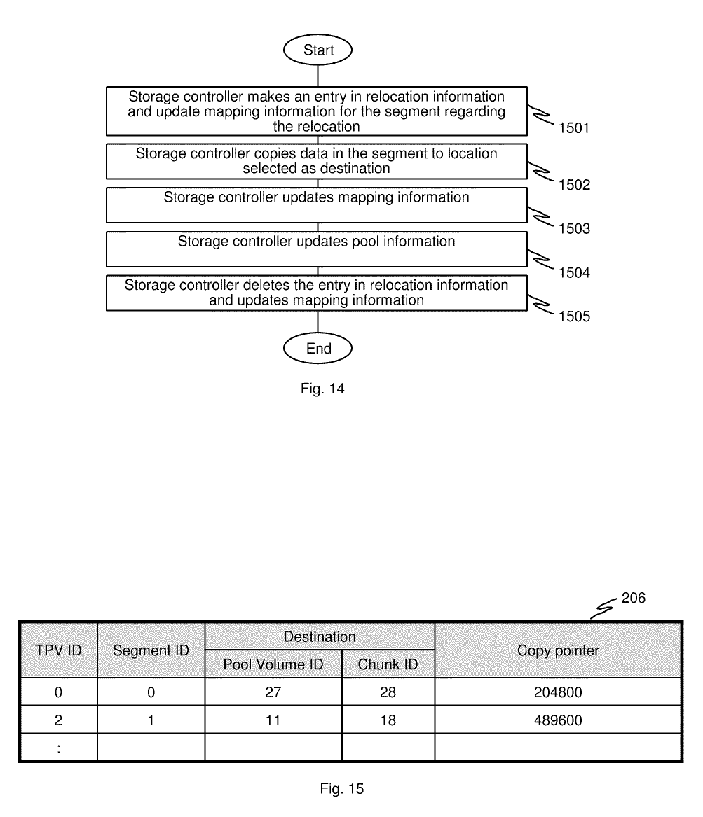

FIG. 14 is a flow diagram illustrating the relocation process in step 1406 of FIG. 12. At step 1501, the storage controller 110 makes an entry in the relocation information 206 for the segment to be moved. FIG. 15 shows an example of the relocation information 206. The relocation information 206 has the ID of the segment to be moved, information regarding the unused location selected as destination, and copy pointer that denotes progress of copy. The storage controller 110 also sets a flag of “Under Relocation” for the segment in the mapping information 201 to “Yes.” At step 1502, the storage controller 110 copies data in the segment to the location selected as the destination. According to the progress of the copying, the copy pointer in the relocation information 206 is updated and moves forward. At step 1503, after completion of the copying, the storage controller 110 updates the mapping information 201 to change the mapping between the segment and physical location according to the relocation. This realizes the transparent relocation of the segment for the host 500. At step 1504, the storage controller 110 updates the pool information 202 to release the chunk that had the segment if no segment uses the chunk. At step 1505, the storage controller 110 deletes the entry in the relocation information 206 and updates the mapping information to set the flag of “Under Relocation” for the segment to “No.”

A.9. Write Process for Conventional Volume

According to embodiments of this invention, the access information 204 is recorded (i.e., access characteristics is monitored) also for the conventional volumes 630 if a flag of “Record Access Information” in the volume information 203 is “Yes.” This flag may be set and changed for the conventional volume 630 by the user via the host 500, management computer 520, and/or management terminal of the storage system 100. The default value of this flag is ‘Yes’.

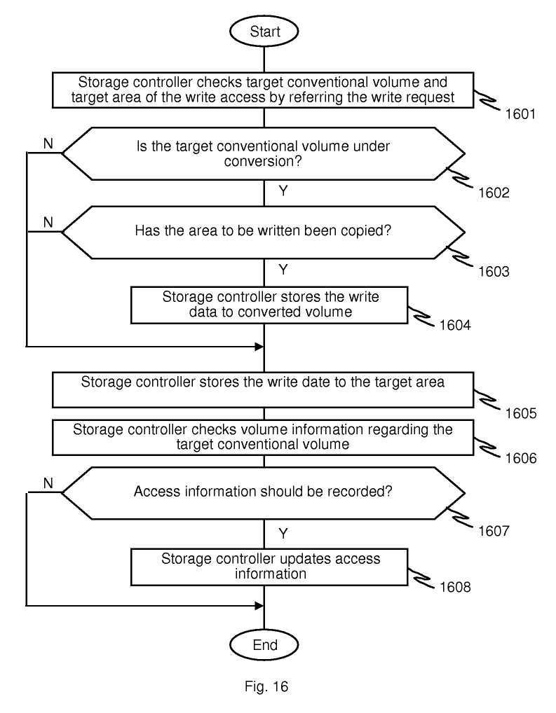

FIG. 16 is a flow diagram illustrating a write process for the conventional volume 630. At step 1601, the storage controller 110 checks the target conventional volume 630 and target area of the write access by referring to the write request. At step 1602, the storage controller 110 checks the “Under Conversion” flag in the volume information 203. The “Under Conversion” flag is set in the conversion process described below and shows whether the volume is under conversion as source of conversion or not. If under conversion, the process proceeds to step 1603. If not, the process proceeds to step 1605.

At step 1603, the storage controller 110 checks whether the area regarding write in the volume has been copied in the conversion process. If yes, the process proceeds to step 1604. If not, the process proceeds to step 1605. At step 1604, the storage controller 110 stores the write data to the converted volume, and then the process proceeds to step 1605. At step 1605, the storage controller 110 stores the write data to the target area of the write access. At step 1606, the storage controller 110 checks the “Record Access Information” flag in the volume information 203 regarding the target conventional volume 630, and determines whether the access information should be recorded in step 1607. If the flag is ‘Yes’, the process proceeds to step 1608. If not, the process ends. At step 1608, the storage controller 110 updates the access information 204.

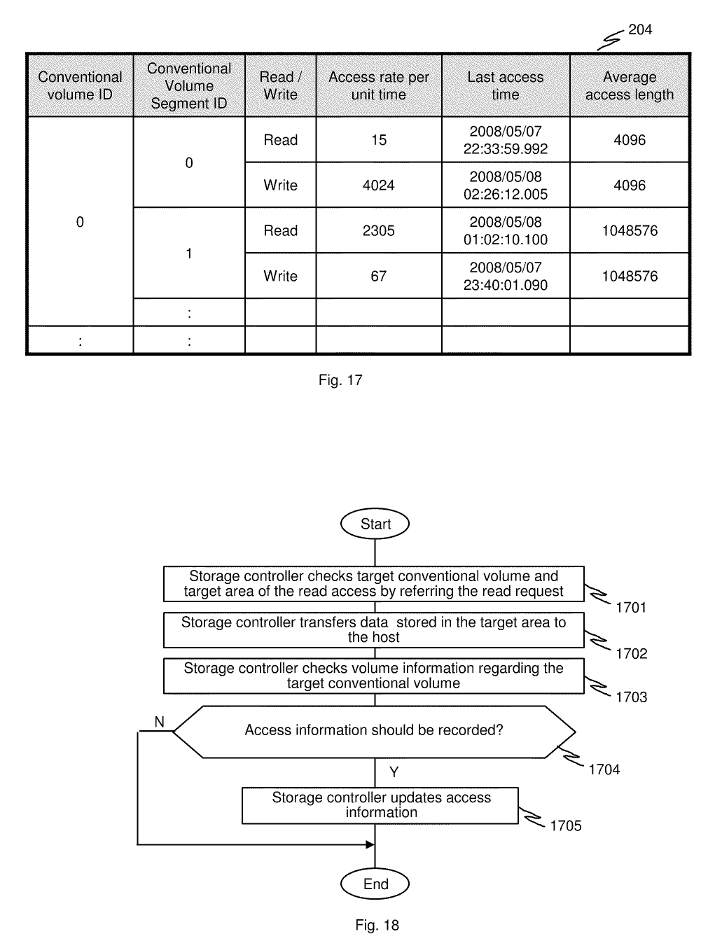

FIG. 17 illustrates an example of the access information 204 for the conventional volume. This is the same as the access information 204 shown in FIG. 10 except for having the conventional volume ID and the conventional volume segment ID. As describe below, the segment ID can be common with the TPV (i.e., the volumes have the same segment size) or can be different from the TPV (i.e., the volumes have different segment size).

A.10. Read Process for Conventional Volume

FIG. 18 is a flow diagram illustrating a read process for the conventional volume 630. At step 1701, the storage controller 110 checks the target conventional volume 630 and target area of the read access by referring to the read request. At step 1702, the storage controller 110 transfers data stored in the target area of the read access to the host 500. At step 1703 and step 1704, the storage controller 110 checks the “Record Access Information” flag in volume information 203 regarding the target conventional volume 630 and determine whether the access information should be recorded. If the flag is “Yes,” the process proceeds to step 1705. If not, the process ends. At step 1705, the storage controller 110 updates the access information 204.

A. 11. Conversion Process

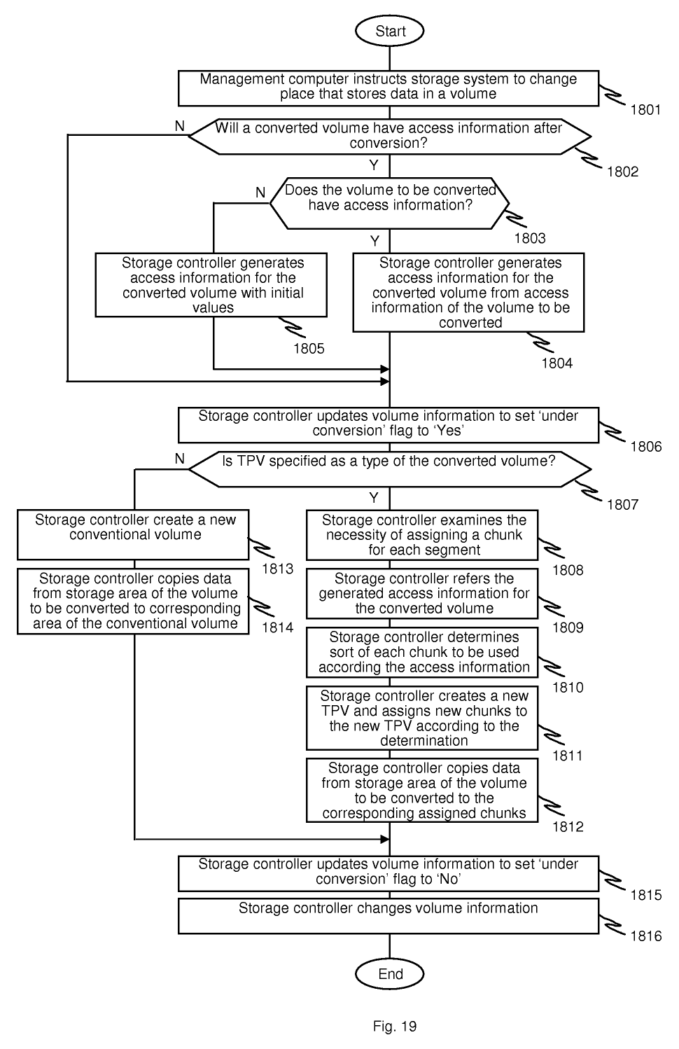

FIG. 19 is a flow diagram illustrating an example of the general conversion process. At step 1801, the management computer 520 instructs the storage controller 110 to change the place of storing data in a volume (i.e., a volume to be converted). This instruction can include the volume ID of the volume to be converted, the type of a volume after conversion (i.e., the type of the converted volume), and the attributes of the converted volumes such as the segment size. It may also specify the “Record Access Information” flag when the type of the converted volume is a conventional volume. At step 1802, the storage controller 110 checks the “Record Access Information” flag of the converted volume in the volume information 203. If the flag is “Yes,” the process proceeds to step 1803. If not, the process proceeds to step 1806.

At step 1803, the storage controller 110 checks the “Record Access Information” flag of the volume to be converted (i.e., whether the volume to be converted has access information or not). If the volume to be converted has access information, the storage controller 110 generates the access information for the converted volume from the access information of the volume to be converted (step 1804). Otherwise, the storage controller 110 generates the access information for the converted volume with initial values for the access information 204 (step 1805). At step 1806, the storage controller 110 sets a flag of “Under Conversion” for the volume to be converted in the volume information 203 to “Yes.”

At step 1807, the storage controller 110 checks the type of the volume specified as the converted volume. If the type is TPV, the process proceeds to step 1808. If the type is conventional volume, the process proceeds to step 1813.

At step 1808 (TPV type), the storage controller 110 examines the necessity of assigning a chunk for each segment of the converted volume. For the converted volume, the segment is defined based on the segment size of the TPV used as the converted volume. As one example of methods for the examination of the necessity, the storage controller 110 can check the data in the segment and can regard a segment as unused segment requiring no assigned actual area (i.e., the necessity of assigning a chunk) when the data is all zero (0) data or a specific predefined pattern of data. At step 1809, the storage controller 110 refers to the access information 204 for the converted volume to select the appropriate chunk for the segments demanding a chunk. At step 1810, the storage controller 110 determines a chunk for each segment of the converted volume according to the access information 204 if the segment needs a chunk. The segment mentioned here is defined by the segment size of the TPV used as the converted volume. At step 1811, the storage controller 110 creates a new TPV and assigns chunks to the TPV by updating the mapping information 201 and pool information 202 based on the plan for the assignment of chunks. At step 1812, the storage controller 110 copies data from the corresponding storage area in the volume to be converted to the assigned chunk. This copy process can be performed with a manner similar to the relocation process in FIG. 14 mentioned above. That is, the storage controller 110 can perform the copy process by preparing and managing progress information. After completion of copy regarding all segments that requires a new chunk, the process proceeds to step 181 5.

At step 1813 (conventional volume type), by updating the volume information 203, the storage controller 110 creates a new conventional volume that will be the converted volume. At step 1814, the storage controller 110 copies data from the volume to be converted to the new conventional volume. This copy process can also be performed with a manner similar to the relocation process in FIG. 14 mentioned above.

Subsequently, at step 1815, the storage controller 110 sets a flag of “Under Conversion” for the volume to be converted in the volume information 203 to “No.” At step 1816, the storage controller 110 changes the public volume ID for the volume to be converted to the ID of the created volume. In other words, the storage controller 110 changes the relation (mapping) between the volume to be converted and the actual converted volume with maintaining exposed ID as transparent migration by updating the volume information 203.

With the method described above, prompt improvement of utilization of storage resources with thin provisioning and automated page-based hierarchical storage management are achieved even with having conversion of volumes between conventional volume and TPV. Especially by using the above conversion process, proper usage of storage resources immediately after the creation of the TPV based on the past access characteristics can be accomplished.

A.12. Another example of Conversion process

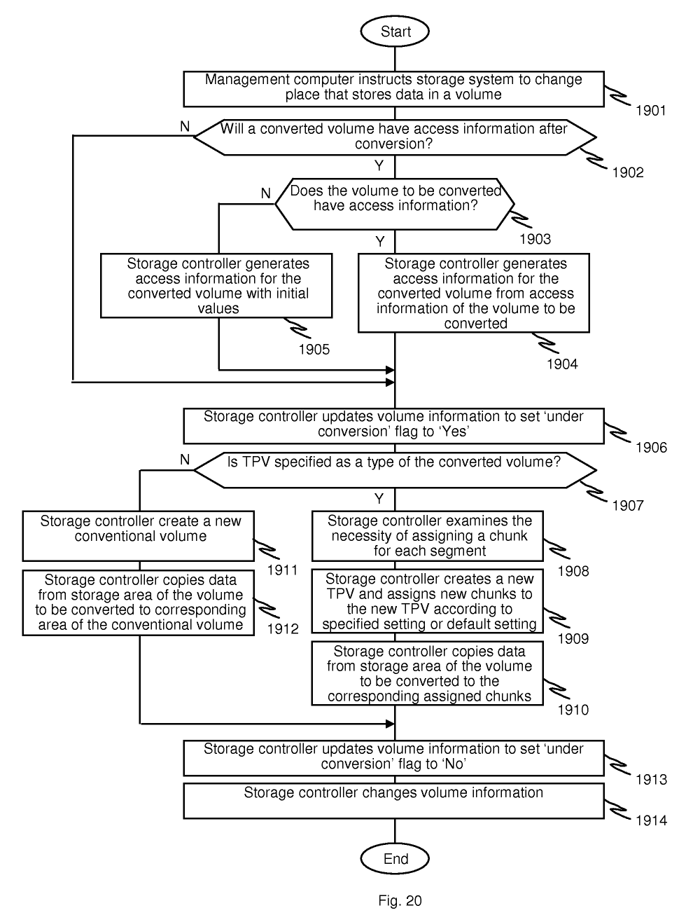

FIG. 20 is a flow diagram illustrating another example of the general conversion process. This process is basically the same as the process shown in FIG. 19; however, this process includes step 1909 instead of step 1809, step 1810, and step 1811. At step 1909, the storage controller 110 creates a new TPV and assigns chunks to the TPV by updating the mapping information 201 and pool information 202 according to designation specified in the above instruction of conversion or default setting. By using the above conversion process, proper usage of storage resources immediately after the creation of the TPV according to user's policy can be realized.

A.13. Correspondence Relation of Segment between Volume to be Converted and Converted Volume

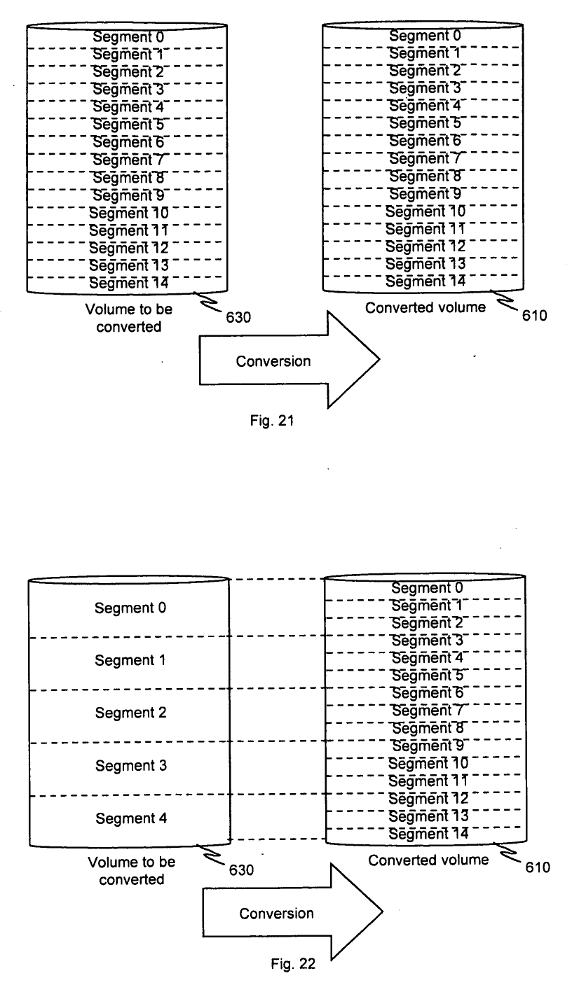

FIGS. 21-23 show examples of segment relation between a volume to be converted and a converted volume, i.e., between the source and destination of conversion.

In FIG. 21, a segment in the volume to be converted and a segment in the converted volume have the same size. In this case, all values in the access information for the volume to be converted (i.e., old access information) is used as the access information for the converted volume (i.e., new access information) according to the correspondence.

In FIG. 22, a segment in the volume to be converted has the segment size that is equal to the integral multiple of the segment size of the converted volume. In this case, some of the values in the old access information such as last access time and average access length are used as the new access information, while some values in the old access information such as access frequency are dispersed, in multiple segments corresponding to one segment of the volume to be converted, in the new access information. For example, 450 of access rate is dispersed to 150 (i.e., average value) when the segment size of the volume to be converted has three times the length as the segment size of the converted volume.

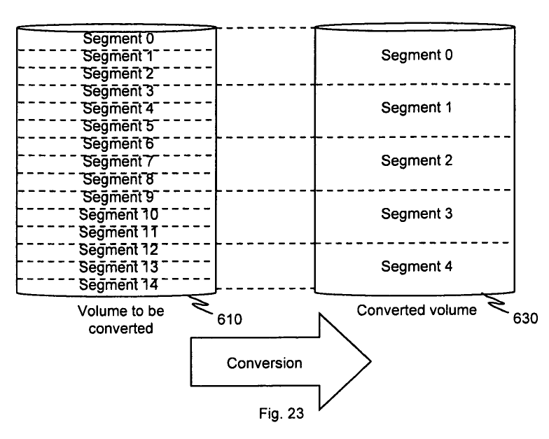

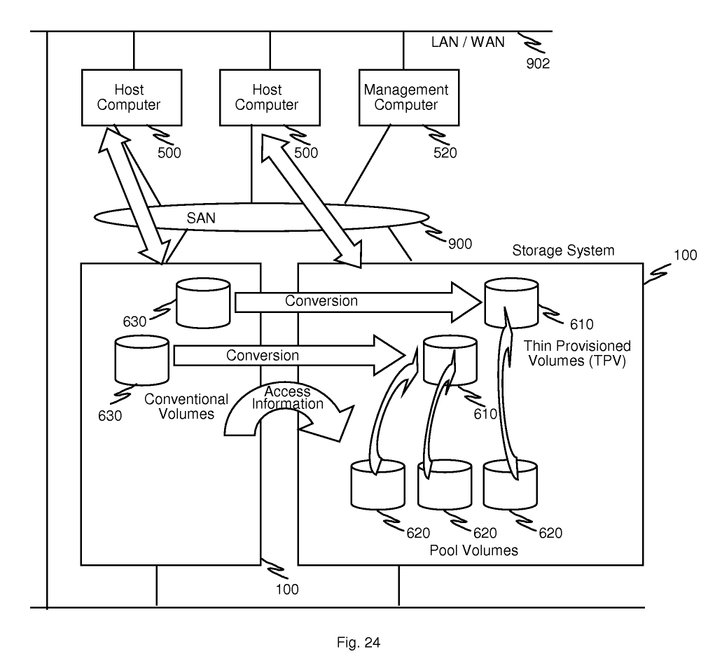

In FIG. 23, a segment in the converted volume has the segment size that is equal to the integral multiple of the segment size of the volume to be converted. In this case, some of the values in the old access information such as last access time and average access length are used as the new access information, while some values in the old access information such as access frequency are aggregated to one corresponding segment in the new access information. For example, 150, 200 and 100 of access rate for three segments in the volume to be converted is collected to 450 for one corresponding segment of the converted volume when the segment size of the converted volume has three times the length as the segment size of the volume to be converted.

One of the advantages of having such flexibility or selectability of the segment size is the achievement of applying large segment size for conventional volumes. That is, as shown above, the segment size of conventional volumes can be the integral multiple of the segment size of the thin provisioned volumes. It is reasonable because the access information is just recorded and is not used for the relocation for conventional volumes, and maintaining the access information of small (i.e., a large number of) segments requires a large amount of memory area in the memory 200 or disk 600. As mentioned above, the segment size of a volume that has the possibility to become a volume to be converted (e.g., a conventional volume in FIG. 1) may be determined with consideration for the segment size of a volume that has the possibility to become a converted volume (e.g., a TPV in FIG. 1).

The correspondence of segments can be acquired by calculation with the segment number and segment size. For example, (a start address of one segment in one volume)=(segment number of the segment)×(segment size of the volume), and then (the segment number of the corresponding segment in the other volume)=(the address)/(segment size of the other volume). The offset can be obtained as deference of the start address of the segments.

The recorded access information for the conventional volumes 630 and TPVs 610 can be transferred to the management computer 520 via SAN 900 and/or LAN 902. That is, it can be obtained, monitored, analyzed, displayed and reported by the management computer 520. It may also be used to make a policy or plan for data management and volume management including charging.

### B. Second Embodiment

FIG. 24 illustrates an overview of conversion from conventional volumes to thin provisioned volumes (TPVs) according to another embodiment of the invention. In this embodiment, there are multiple storage systems 100 that posses the same components, process, and capability as the storage system 100 shown in the first embodiment (FIG. 1). The host computers 500 and management computer 520 are connected to the storage systems 100 by the SAN 900 and LAN 902. Each storage system 100 can provide volumes to these computers. In the example shown in this figure, a volume (e.g., a conventional volume 630) in one storage system 100 can be converted (migrated) to another volume (e.g., a TPV 610) in the other storage system 100. Generally path management software or other virtualization techniques such as a method disclosed in U.S. Pat. No. 7,162,600 are known for the volume migration like this.

By copying and applying the access information 240 from one storage system having the volume to be converted (i.e., source of migration) to the other storage system 100 having the converted volume (i.e., destination of migration) via the SAN 900 or LAN/WAN 902, prompt improvement of utilization of storage resources with thin provisioning and automated page-based hierarchical storage management are achieved even with having conversion of volumes between conventional volume and TPV among multiple storage systems 100. In other words, by using processes described in the first embodiment to the system configuration with multiple storage systems 100, the same consequence is achieved even in the multiple storage systems 100. That is, plural storage systems exchange access characteristics information to maintain history of access characteristic with conversion of volumes between the storage systems 100.

Of course, the system configurations illustrated in FIGS. 1, 2, and 24 are purely exemplary of information systems in which the present invention may be implemented, and the invention is not limited to a particular hardware configuration. The computers and storage systems implementing the invention can also have known I/O devices (e.g., CD and DVD drives, floppy disk drives, hard drives, etc.) which can store and read the modules, programs and data structures used to implement the above-described invention. These modules, programs and data structures can be encoded on such computer-readable media. For example, the data structures of the invention can be stored on computer-readable media independently of one or more computer-readable media on which reside the programs used in the invention. The components of the system can be interconnected by any form or medium of digital data communication, e.g., a communication network. Examples of communication networks include local area networks, wide area networks, e.g., the Internet, wireless networks, storage area networks, and the like.

In the description, numerous details are set forth for purposes of explanation in order to provide a thorough understanding of the present invention. However, it will be apparent to one skilled in the art that not all of these specific details are required in order to practice the present invention. It is also noted that the invention may be described as a process, which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged.

As is known in the art, the operations described above can be performed by hardware, software, or some combination of software and hardware. Various aspects of embodiments of the invention may be implemented using circuits and logic devices (hardware), while other aspects may be implemented using instructions stored on a machine-readable medium (software), which if executed by a processor, would cause the processor to perform a method to carry out embodiments of the invention. Furthermore, some embodiments of the invention may be performed solely in hardware, whereas other embodiments may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

From the foregoing, it will be apparent that the invention provides methods, apparatuses and programs stored on computer readable media for recording and utilizing access information in a conversion process. With this invention, efficient use and assignation of storage resources based on past access characteristics can be performed immediately. Additionally, while specific embodiments have been illustrated and described in this specification, those of ordinary skill in the art appreciate that any arrangement that is calculated to achieve the same purpose may be substituted for the specific embodiments disclosed. This disclosure is intended to cover any and all adaptations or variations of the present invention, and it is to be understood that the terms used in the following claims should not be construed to limit the invention to the specific embodiments disclosed in the specification. Rather, the scope of the invention is to be determined entirely by the following claims, which are to be construed in accordance with the established doctrines of claim interpretation, along with the full range of equivalents to which such claims are entitled.

What is claimed is:

1. A method for providing storage volumes which are to be converted to thin provisioned volumes, the method comprising:
receiving from a host computer a read/write request identifying a target storage volume among the storage volumes and a target area of access;
if the read/write request is a read request, transferring data stored in the target area of access of the target storage volume to the host computer, and updating an access information of the target storage volume;
if the read/write request is a write request containing write data, storing the write data in the target area of access of the target storage volume, and updating an access information of the target storage volume;
if the target storage volume does not have access information, generating access information for the converted thin provisioned volume from initial values; and
if the target storage volume has access information, generating access information for the converted thin provisioned volume based on the access information of the target storage volume.

2. A method according to claim 1, further comprising:
determining whether there is a need to relocate data in the converted thin provisioned volume by referring to the generated access information.

3. A method according to claim 1, further comprising:
prior to updating the access information of the target storage volume, determining whether to update the access information by checking a “record access information” flag in a volume information regarding the target storage volume.

4. A method according to claim 1,
wherein the size of segments of the target storage volume is equal to an integral multiple of the segment size of the thin provisioned volume.

5. A method according to claim 1, wherein during a relocation process of the converted thin provisioned volume, the method further comprises:
determining a location that stores data in the converted thin provisioned volume by using the generated access information.

6. A method according to claim 1, wherein the access information for the thin provisioned volume is generated based on the access information of the target storage volume, the method further comprising:
for each segment of a plurality of segments of the thin provisioned volume, determining whether there is a need to assign a chunk for said each segment; and
if there is a need to assign a chunk for said each segment, determining a chunk to be assigned for said each segment according to the access information of the thin provisioned volume, assigning the chunk for said each segment, and copying data from the target storage volume to the assigned chunk.

7. A method according to claim 1, wherein the storage volumes are disposed in a first storage system and are to be converted to the thin provisioned volumes disposed in a second storage system.

8. A system for providing storage volumes which are to be converted to thin provisioned volumes, the system comprising:
a host computer; and
a first storage system connected with the host computer via a network, wherein the first storage system includes a first storage area and a storage controller which has a processor, and wherein
the storage controller is configured to receive from a host computer a read/write request identifying a target storage volume among the storage volumes in the first storage area of the first storage system, and a target area of access;
if the read/write request is a read request, the storage controller transfers data stored in the target area of access of the target storage volume to the host computer, and updates an access information of the target storage volume;
if the read/write request is a write request containing write data, the storage controller stores the write data in the target area of access of the target storage volume, and updates an access information of the target storage volume;
if the target storage volume does not have access information, the storage controller generates access information for the converted thin provisioned volume from initial values; and
if the target storage volume has access information, the storage controller generates access information for the converted thin provisioned volume based on the access information of the target storage volume.

9. A system according to claim 8, wherein
wherein the storage controller determines whether there is a need to relocate data in the converted thin provisioned volume by referring to the generated access information.

10. A system according to claim 8,
wherein prior to updating the access information of the target storage volume, the storage controller determines whether to update the access information by checking a “record access information” flag in a volume information regarding the target storage volume.

11. A system according to claim 8,
wherein the size of segments of the target storage volume is equal to an integral multiple of the segment size of the thin provisioned volume.

12. A system according to claim 8, wherein during a relocation process of the converted thin provisioned volume, the storage controller determines a location that stores data in the converted thin provisioned volume by using the generated access information.

13. A system according to claim 8, wherein the access information for the thin provisioned volume is generated based on the access information of the target storage volume, wherein
for each segment of a plurality of segments of the thin provisioned volume, the storage controller determines whether there is a need to assign a chunk for said each segment; and
if there is a need to assign a chunk for said each segment, the storage controller determines a chunk to be assigned for said each segment according to the access information of the thin provisioned volume, assigns the chunk for said each segment, and copies data from the target storage volume to the assigned chunk.

14. A system according to claim 8, further comprising:
a second storage system connected with the first storage system, wherein the second storage system includes a second storage area;
wherein the storage volumes are disposed in the first storage area of the first storage system and are to be converted to the thin provisioned volumes disposed in the second storage area of the second storage system.

15. A computer-readable storage medium storing a plurality of instructions for controlling a data processor to provide storage volumes which are to be converted to thin provisioned volumes, the plurality of instructions comprising:
instructions that cause the data processor to receive from a host computer a read/write request identifying a target storage volume among the storage volumes and a target area of access;
if the read/write request is a read request, instructions that cause the data processor to transfer data stored in the target area of access of the target storage volume to the host computer, and update an access information of the target storage volume;
if the read/write request is a write request containing write data, instructions that cause the data processor to store the write data in the target area of access of the target storage volume, and update an access information of the target storage volume;
if the target storage volume does not have access information, instructions that cause the data processor to generate access information for the converted thin provisioned volume from initial values; and
if the target storage volume has access information, instructions that cause the data processor to generate access information for the converted thin provisioned volume based on the access information of the target storage volume.

16. A computer-readable storage medium according to claim 15, wherein the plurality of instructions further comprise:
instructions that cause the data processor to determine whether there is a need to relocate data in the converted thin provisioned volume by referring to the generated access information.

17. A computer-readable storage medium according to claim 15, wherein the plurality of instructions further comprise:
prior to updating the access information of the target storage volume, instructions that cause the data processor to determine whether to update the access information by checking a “record access information” flag in a volume information regarding the target storage volume.

18. A computer-readable storage medium according to claim 15, wherein the size of segments of the target storage volume is equal to an integral multiple of the segment size of the thin provisioned volume.

19. A computer-readable storage medium according to claim 15, wherein the plurality of instructions further comprise:
during a relocation process of the converted thin provisioned volume, instructions that cause the data processor to determine a location that stores data in the converted thin provisioned volume by using the generated access information.

20. A computer-readable storage medium according to claim 15, wherein the access information for the thin provisioned volume is generated based on the access information of the target storage volume, and wherein the plurality of instructions further comprise:
for each segment of a plurality of segments of the thin provisioned volume, instructions that cause the data processor to determine whether there is a need to assign a chunk for said each segment; and
if there is a need to assign a chunk for said each segment, instructions that cause the data processor to determine a chunk to be assigned for said each segment according to the access information of the thin provisioned volume, assign the chunk for said each segment, and copy data from the target storage volume to the assigned chunk.
